(19) United States
(12) Patent Application Publication
(10) Pub. No.: US 2006/0268291 A1
(43) Pub. Date: Nov. 30, 2006

(54) Image forming device and method for processing image data using the same and system for transmission of image data

(75) Inventor: Young-ho Yoo, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/366,595

(22) Filed: Mar. 3, 2006

(30) Foreign Application Priority Data
May 30, 2005 (KR) 2005-45570

(51) Int. Cl. G06K 15/02

(52) U.S. Cl. 358/1.2; 358/505

(57) ABSTRACT

An image forming device, a method for processing image data, and a system for transmitting image data, with the image data transmission system including an image forming device reading out scan data to generate image data and compressing the generated image data into a predetermined or selected form for transmitting, and a wireless terminal device connected over a cable to the image forming device and receiving the compressed image data over the cable from the image forming device. Therefore, it is possible to transmit image data, although the image forming device has no dedicated communication module.

### CROSS-REFERENCE TO RELATED APPLICATIONS

This application claims the benefit of Korean Patent Application No. 2005-45570, filed May 30, 2005, in the Korean Intellectual Property Office, the disclosure of which is incorporated herein by reference.

### BACKGROUND OF THE INVENTION

1. Field of the Invention

Aspects of the invention relate to an image forming device, a method for processing image data, and a system for transmitting image data. More particularly, aspects of the invention relates to an image forming device which can easily transmit and receive scan data without necessarily requiring a separate communication module, the method for processing image data, and the system for transmitting image data.

2. Description of the Related Art

Various input and output devices are typically incrementally used due to office automation, and among such devices is an image forming apparatus, such as a Laser beam printer, a Led print head (LPH) printer, and a copier.

A conventional image forming device typically has one individual function, such as a printer or a copier. On the other hand, a multi function printer (MFP) integrates various functions, such as a printer, a scanner, and a facsimile, in a single device, in view of the development of digital technology. The MFP can have various communication modules to transmit and receive data, in addition to printing and/or scanning functions. For example, the MFP can have a communication module connectable to a public switched telephone network (PSTN) to include a facsimile function which can receive and transmit facsimile data. The MFP can also have a communication module connectable to a network to include a function which can receive and transmit e-mail.

When the MFP has various communication modules, it can provide a multitude of various functions such as the facsimile function, and the e-mail receipt and transmission function. However, the MFP typically is required to have communication modules for each of these functions. A personal MFP, such as used at home, can be easily connected to the network or PSTN, typically because one MFP is connected to one computer. However, the business MFP, such as used in schools and offices, typically has installed dedicated lines for use. Therefore, a user of the business MFP can have disadvantages in that a dedicated facsimile is typically used to transmit facsimile data, or a dedicated computer is typically used to transmit e-mail.

### SUMMARY OF THE INVENTION

Accordingly, aspects of the invention provide an image forming device which can transmit and receive scan data and image data without necessarily requiring dedicated communication modules by connecting the image forming device and a wireless terminal device over a cable, and provide a method thereof for processing image data.

According to another aspect of the present invention, an image forming device includes a scan part reading out scan data to generate image data, an image data process part compressing the generated image data into a transmittable form to an outer wireless terminal device, and a connector part transmitting the compressed image data over a certain cable to the wireless terminal device.

In aspects of the invention, the cable can be a Universal Asynchronous Receiver and Transmitter (UART) type cable or a Universal Serial Bus (USB) type cable.

Also, in aspects of the invention, the image forming device can further include a user input part transmitting at least one request signal, wherein the image data process part converts the image data into an image form that can be associated with, or inserted in, another image data, when a watermark process request signal to associate or insert the image data is received from the user input part.

According to additional aspects of the invention, a method for processing image data of an image forming device with a connector part connectable over a cable as, for example a UART type cable or a USB type cable, to an outer wireless terminal device includes reading out scan data to generate image data, compressing the generated image data into a transmittable form to the wireless terminal device, and transmitting the compressed image data over the connector part to the wireless terminal device.

The method, according to aspects of the invention, can further include converting the image data into an image form that can be associated with, or inserted in, another image data, when a watermark process request signal to associate or insert the image data is received.

According to a further aspect of the invention, a system for transmitting image data includes an image forming device to read out scan data to generate image data and to compress the generated image data into a predetermined form for transmitting, and a wireless terminal device connected over a cable to the image forming device to receive the compressed image data over the cable from the image forming device.

In aspects of the invention, the cable in the system for transmitting image data, can be one of a UART type cable or a USB type cable. The wireless terminal device can transmit the received image data to another wireless terminal device and/or to another image forming device.

Additional aspects and/or advantages of the invention are set forth in or evident from the description which follows, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a system for transmitting image data according to an embodiment of the present invention;

FIG. 2 is a block diagram of an image forming device of FIG. 1 according to an embodiment of the present invention;

FIGS. 3A, 3B and 3C are views for explaining a watermark process of an image data according to aspects of the invention; and

FIG. 4 is a flowchart of a method for processing image data of an image forming device according to an embodiment of the present invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention with reference to the figures.

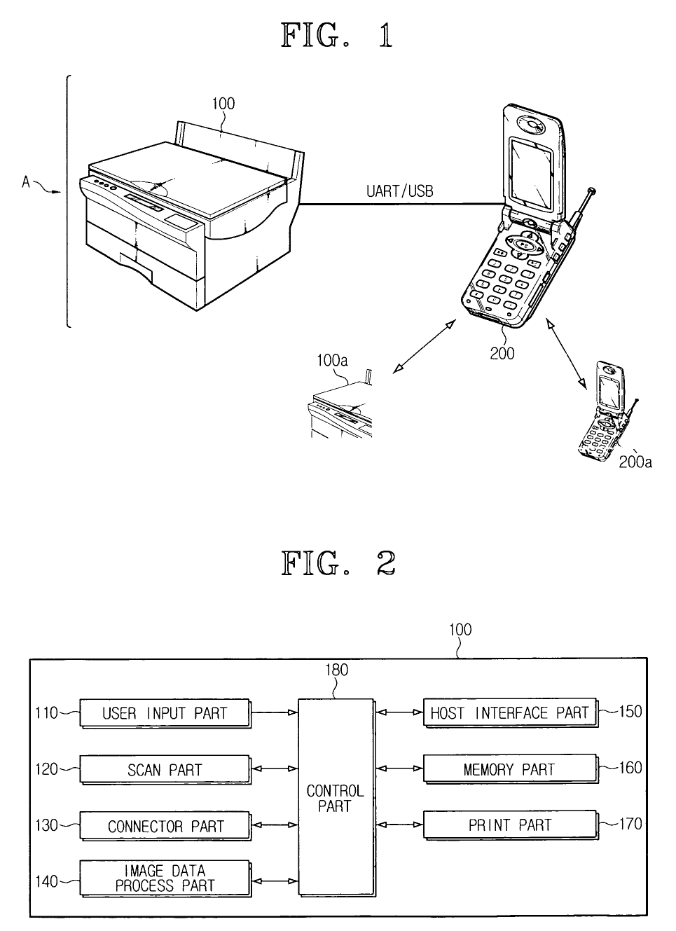

FIG. 1 is a diagram of a system A to transmit image data according to an embodiment of the present invention. Referring to FIG. 1, the system A for transmitting image data includes an image forming device 100 and a wireless terminal device 200. The image forming device 100 and the wireless terminal device 200 can be connected over various cables or cable types, such as a universal asynchronous receiver and transmitter (UART) type cable or a universal serial bus (USB) type cable.

The image forming device 100 can be an integrated scanner/printer that has the combined functions of scanning and printing, and includes a connector part 130 (FIG. 2) connectable to the wireless terminal device 200 over the cable, such as the UART type cable or the USB type cable. The image forming device 100 reads out a document, which can be scan data provided from a user scanning the document, to generate image data corresponding to the scan data, and transmits the image data to the wireless terminal device 200. The image forming device 100 can also print the image data, when necessary.

As mentioned previously, the wireless terminal device 200 connects to the image forming device 100 over a cable such as a UART type cable or a USB type cable. The wireless terminal device 200 can be any of wireless type devices that transmit/receive data, such as a mobile phone or a personal digital assistant (PDA) with a basic communication module. Since the wireless terminal device 200, such as the mobile phone or the PDA, uses the UART type cable or the USB type cable to interface with a computer, such or similar cable type or types can also be applied to interfacing with the image forming device 100.

The wireless terminal device 200 receives image data transmitted in a compression, or compressed, form over a cable from the image forming device 100. The wireless terminal device 200 can transmit the image data from the image forming device 100 to another wireless terminal device or another image forming device. In the system A for transmitting image data of FIG. 1, the image forming device 100 transmits the image data to the wireless terminal device 200. However, according to various aspects of the invention, the wireless terminal device 200 can also transmit image data to the image forming device 100 in the system A of FIG. 1. Additionally, the wireless terminal device 200 can transmit the received image data to another wireless terminal device 200a, or the wireless terminal device 200 can transmit the received image data to another image forming device 100a, such as by a cable as the UART type cable or the USB type cable, wirelessly, or over other types of transmission media, such as illustrated in FIG. 1.

FIG. 2 is a block diagram of the image forming device 100 according to an embodiment of the present invention. Referring to FIG. 2, the image forming device 100 includes a user input part 110, a scan part 120, a connector part 130, an image data process part 140, a host interface part 150, a memory part 160, a print part 170, and a control part 180.

When a user selects an operation or function using the user input part 110, the user input part 110 inputs at least one request signal to the control part 180. Generally, the user input part 110 can include a keyboard or a plurality of function keys, corresponding to selected or predetermined functions or operations, such as can be provided in a front panel of the image forming device 100.

In the image forming device 100, the request signal input to the control part 180 from the user input part 110 can include, for example, a scan request signal to start scanning a medium, such as a document, to provide scan data, a transmission request signal to transmit the image data generated from the scan data to the wireless terminal device 200, and a watermark process request signal for watermark processing the image data.

The scan part 120 reads out a document provided as a user performs general scanning, which provides scan data, to generate image data. General scanning is typically a function of the image forming device 100 that optically scans a medium, such as a film, a photograph, a document, and/or a drawing, such as to measure degrees of reflected light or transmitted light, and performs an analog to digital (A/D) conversion to obtain a digital image of the scanned medium. The wireless terminal device 200 can also transmit data, such as scan data, to the image forming device 100 to generate image data.

The connector part 130 connects the image forming device 100 and the wireless terminal device 200 over a cable, such as a USB type cable or a UART type cable, and can be any of a suitable type of connector. When a user makes a request, the connector part 130, which can also include or be associated with a transmitter, transmits the image data over the cable to the wireless terminal device 200, when the image data process part 140 has compressed the image data under control of the control part 180.

The image data process part 140, as mentioned, compresses the image data from the scan part 120 into a transmittable form suitable for transmission to the wireless terminal device 200. The image data process part 140 can also convert the image data from the scan part 120 into a form that can be associated with, such as being inserted in or with, another image data, when a watermark process command for the image data is input under control of the control part 180. The image data process part 140 can watermark-process the image data, such as when the image data is a photograph or a special character form.

The host interface part 150 can provide an interface between the image forming device 100 and a control or processor type device that can transmit/receive data, or transmit/execute/receive functions, operations or commands, such as a computer (not shown) or processor. The host interface part 150 can transmit a print command and print data received from the command or control device, such as a computer or processor, to the image forming device 100, or can transmit an operation status of the image forming device 100 to the control or processor type device. In aspects of the invention, various request signals can be input to the image forming device 100 via the user input part 110. However, a user can also select various functions via drivers installed in the command or control device, such as a computer or processor, and the corresponding request signals can be input to the image forming device 100 via the host interface part 150.

The memory part 160 includes a suitable memory, such as a non-volatile type memory, that stores various control programs or software to implement functions or operations of the image forming device 100, and can also store data on other than a temporary basis, as necessary. The memory part 160 also includes a suitable memory, such as a volatile type memory, to temporarily store data, such as data generated by performing a program or programs executed under the control of the control part 180, or to temporarily store software or programs to carry out selected functions or operations under control of the control part 180. In this regard, the memory part 160 can temporarily store the scan data or the image data generated from the scan part 120 until the image data is compressed by the image data process part 140 to transmit to the wireless terminal device 200, or store data received from the wireless terminal device 200.

The print part 170, such as a printer, prints the data as print data onto a medium, such as a print paper, by a general process, and can also print the image data as the scan part 120 generates the image data under control of the control part 180.

The control part 180 controls general functions of the image forming device 100. Also, the control part 180 controls inputting and outputting signals between each of the user input part 110, the scan part 120, the connector part 130, the image data process part 140, the host interface part 150, the memory part 160, and the print part 170. The control part 180, such as a processor, microprocessor or an application specific integrated circuit (ASIC), with associated memory and software or programming, implements the functions or operations of the image forming device 100.

Additionally, the control part 180 controls the compression of the image data compressed by the image data process part 140 and controls the transmission of the compressed image data to the wireless terminal device 200 over the connector part 130, such as when a transmission request signal to transmit the image data is received from the user input part 110. The control part 180 also controls the image data process part 140 to convert the image data into a form that can be associated with, such as being inserted in or with another image data, and controls the print part 170 to associate, or insert, the converted image data in or with a proper, predetermined or selected position of the other image data for printing, such as when the watermark process request signal to associate, or insert, the image data is received from the user input part 110.

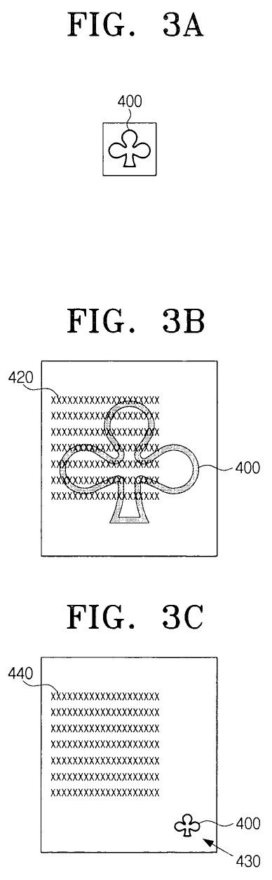

FIGS. 3A, 3B and 3C are views illustrating a watermark process to associate or insert image data in or with another image data, using the image forming apparatus 100 of FIGS. 1 and 2. When a user desires to watermark-process image data, in other words, when a user desires to use the image data as a background of another image data, or insert the image data in a certain, predetermined or selected position of a medium, such as a print paper when printing another image data, a user inputs the watermark process request signal to the image data via the user input part 110. When the watermark process request signal to associate, or insert, the image data is received by the control part 180 from the user input part 110, the image data process part 140 converts the image data into a form that can be associated, or inserted, in another image data under control of the control part 180.

Referring to FIGS. 3A, 3B and 3C, FIG. 3A illustrates image data 400 generated from the scan part 120, and the image data process part 140 converts the image data 400 into a form that can be associated with, or inserted in, another image data. When a user desires to use the image data 400 of FIG. 3A as a background or imposed upon all or part of another image data, the image data 400 can be inserted into or imposed on the other image data 420, such as illustrated in FIG. 3B, and can be then printed, such as illustrated in FIG. 3B. Further, when a user desires to use the image data 400 of FIG. 3A as an insert in or at a selected position 430, such as at a bottom end of the other image data 440, as illustrated in FIG. 3C, the image data 400 can be inserted at, in or be associated with the selected position 430 in relation to the other image data 440, such as illustrated in FIG. 3C, and can then be printed, such as illustrated in FIG. 3C.

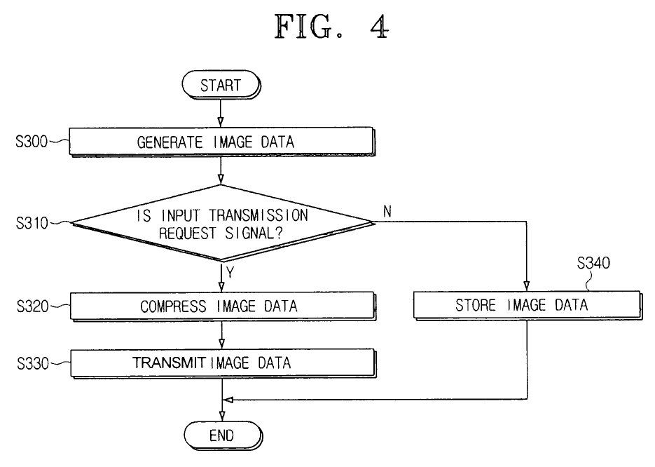

FIG. 4 is a flowchart of a method for processing an image data of an image forming device according to an embodiment of the present invention. The method for processing an image data of the image forming device 100 according to an embodiment of the present invention will be explained in detail with reference to FIGS. 1 through 4.

When a scan request signal from the user input part 110 is received, the scan part 120 of the image forming device 100 reads out scan data provided from a user to generate image data at operation S300 under control of the control part 180. Alternatively, a scan request signal can be received from the wireless terminal device 200 and, when a scan request signal is received from the wireless terminal device 200, the scan part 120 of the image forming device 100 reads out scan data provided from a user to generate image data at operation S300 under control of the control part 180, and the scan data can also be alternatively transmitted from the wireless terminal device 200. Such transmission of scan data from the wireless terminal device 200 to the image forming device 100 can be requested, for example, when other image data is to be associated with, or inserted in, scan data transmitted from the wireless terminal device 200 or when the user desires to print data transmitted or received from the wireless terminal device 200. The image data generated from the scan part 120 can be temporarily stored to the memory part 160 (operation S300).

Then, when a user desires to transmit the image data generated from the scan part 120 to the wireless terminal device 200, and when a transmission request signal to the image data is received from the user input part 110, or a transmission request is received by the image forming device 100 from the wireless terminal device 200, to the control part 180, the image data process part 140 compresses the image data into a transmittable form to the wireless terminal device 200 under control of the control part 180 (operations S310 to S320).

When the image data process part 140 completes the compression of the image data, the control part 180 controls the connector part 130 to transmit the compressed image data to the wireless terminal device 200 over the connector part 130 (operation S330). However, in operation S310, when the image data is generated from the scan part 120 but the transmission request signal to transmit the image data from the user input part 110, or from the wireless terminal device 200, is not received, the generated image data can be stored in the memory part 160 (operation S340).

As described above with respect to FIG. 4, the image data generated from the scan part 120 can be transmitted to the wireless terminal device 200, such as when a user operates the user input part 110 or when the user transmits a request from the wireless terminal 200. However, the image data can be directly transmitted to the wireless terminal device 200, without the process of inputting the transmission request signal to the image data via the user input part 110.

Therefore, a general facsimile function can be implemented by using the image forming device 100 according to embodiments and/or aspects of the invention without the communication module with the PSTN to transmit the facsimile data. In this regard, for example, when the image data is generated from the scan part 120, the image data process part 140 compresses the generated image data into a transmittable form to the wireless terminal device 200 and transmits the compressed image data over the connector part 130 to the wireless terminal device 200 under control of the control part 180, although the transmission request signal is not received from the user input part 110.

The image data transmission system, such as similar to the system A of FIG. 1, according to other embodiments and/or aspects of the invention, can be implemented by installing the image forming device 100 in public facilities, such as schools and libraries. Additionally, when an image data transmission system, according to aspects of the invention, is implemented in such public or semi-public facilities, consideration can be given to charging for the use of the system.

In this regard, for example, when a user desires to print the image data stored in the user's wireless terminal device 200, the user needs to connect the wireless terminal device 200 over the cable to the image forming device 100 and download the image data from the wireless terminal device 200 to the image forming device 100 in order to obtain a print result for the image data via the image forming device 100. In this case, a use fee of the image forming device 100 can be charged in the communication fee of the wireless terminal device 200 and, therefore, a separate billing machine or other separate billing arrangement is typically not necessary.

The image forming device 100, the method for processing the image data, and the system for transmitting the image data according to embodiments and/or aspects of the invention have advantages in that the image data is easily transmitted without requiring a separate dedicated communication module in the image forming device 100, by connecting the wireless terminal device 200 with communication modules and the image forming device 100 over the cable.

The foregoing embodiments, aspects and advantages are merely exemplary and are not to be construed as limiting the present invention. Also, the description of the embodiments of the present invention is intended to be illustrative, and not to limit the scope of the claims, and various other alternatives, modifications, and variations will be apparent to those skilled in the art. Therefore, although a few embodiments of the present invention have been shown and described, it would be appreciated by those skilled in the art that changes may be made in the embodiments without departing from the principles and spirit of the invention, the scope of which is defined in the claims and their equivalents.

1. An image forming device, comprising:
a scan part to read out scan data to generate image data;
an image data process part to compress the generated image data into a transmittable form to transmit to a wireless terminal device; and
a connector part to transmit the compressed image data over a cable to the wireless terminal device.

2. The device as claimed in claim 1, wherein the cable comprises one of a Universal Asynchronous Receiver and Transmitter (UART) type cable and a Universal Serial Bus (USB) type cable.

3. The device as claimed in claim 1, further comprising:
a user input part to transmit at least one request signal,
wherein the image data process part converts the image data into a form that is insertable in another image data, when a watermark process request signal to insert the image data into the other image data is received from the user input part.

4. A method of processing image data of an image forming device with a connector part connectable over a cable to a wireless terminal device, comprising:
reading out scan data to generate image data;
compressing the generated image data into a transmittable form to transmit to the wireless terminal device; and
transmitting the compressed image data over the connector part to the wireless terminal device.

5. The method as claimed in claim 4, wherein the cable comprises one of a Universal Asynchronous Receiver and Transmitter (UART) type cable and a Universal Serial Bus (USB) type cable.

6. The method as claimed in claim 4, further comprising:
converting the image data into a form that is insertable in another image data, when a watermark process request signal to insert the image data is received.

7. A system for transmitting image data, comprising:
an image forming device to read out scan data to generate image data and to compress the generated image data into a transmittable form; and
a wireless terminal device to connect over a cable to the image forming device and to receive the compressed image data over the cable from the image forming device.

8. The system as claimed in claim 7, wherein the cable comprises one of a Universal Asynchronous Receiver and Transmitter (UART) type cable and a Universal Serial Bus (USB) type cable.

9. The system as claimed in claim 7, wherein the wireless terminal device transmits the received image data to another wireless terminal device.

10. The system as claimed in claim 7, wherein the wireless terminal device transmits the received image data to another image forming device.

11. The system as claimed in claim 7, wherein the wireless terminal device transmits the scan data to the image forming device to generate the image data.

12. The system as claimed in claim 7, wherein the image forming device transmits or receives the scan data or the image data without a separate dedicated communication module for the transmission or reception of the scan data or the image data.

13. The system as claimed in claim 7, wherein the image forming device comprises:
a scan part to read out scan data to generate image data;
an image data process part to compress the generated image data into a transmittable form to transmit to the wireless terminal device; and
a connector part to transmit the compressed image data over a cable to the wireless terminal device.

14. The system as claimed in claim 13, wherein the cable comprises one of a Universal Asynchronous Receiver and Transmitter (UART) type cable and a Universal Serial Bus (USB) type cable.

15. system as claimed in claim 14, wherein the image forming device transmits or receives the scan data or the image data without a separate dedicated communication module for the transmission or reception of the scan data or the image data.

16. The system as claimed in claim 13, wherein the image forming device transmits or receives the scan data or the image data without a separate dedicated communication module for the transmission or reception of the scan data or the image data.

17. The system as claimed in claim 13, further comprising:
a user input part to transmit at least one request signal,
wherein the image data process part converts the image data into a form that is insertable in another image data, when a watermark process request signal to insert the image data into the other image data is received from the user input part.

18. The system as claimed in claim 17, wherein an image forming device transmits or receives the scan data or the image data without a separate dedicated communication module for the transmission or reception of the scan data or the image data.

19. The system as claimed in claim 13, wherein the image data process part converts the image data into a form to associate with another image data.

20. The system as claimed in claim 19, wherein an image forming device transmits or receives the scan data or the image data without a separate dedicated communication module for the transmission or reception of the scan data or the image data.

21. The system as claimed in claim 13, wherein the wireless terminal device transmits the received image data to another wireless terminal device.

22. The system as claimed in claim 13, wherein the wireless terminal device transmits the received image data to another image forming device.

23. The system as claimed in claim 13, wherein the wireless terminal device transmits the scan data to the image forming device to generate the image data.

24. A system for transmitting image data, comprising:
an image forming device to read out scan data to generate image data and to compress the generated image data into a form to transmit without a separate dedicated communication module for the transmission; and
a wireless terminal device to connect over a cable to the image forming device and to receive the compressed image data over the cable from the image forming device.

25. The system as claimed in claim 24, wherein the cable comprises one of a Universal Asynchronous Receiver and Transmitter (UART) type cable and a Universal Serial Bus (USB) type cable.

26. The system as claimed in claim 24, wherein the wireless terminal device transmits a request to the image forming device to transmit the compressed image data.

27. The system as claimed in claim 24, wherein the image forming device transmits the compressed image data without receiving a transmission request signal.

28. The system as claimed in claim 27, wherein the image forming device performs a facsimile function in transmitting the compressed image data.

29. An image forming device, comprising:
a scan part to read out scan data to generate image data;
an image data process part to compress the generated image data into a transmittable form to transmit to a wireless terminal device without a separate dedicated communication module for the transmission; and
a connector part to transmit the compressed image data over a cable to the wireless terminal device.

30. The device as claimed in claim 29, wherein the cable comprises one of a Universal Asynchronous Receiver and Transmitter (UART) type cable and a Universal Serial Bus (USB) type cable.

31. The device as claimed in claim 30, further comprising:
a user input part to transmit at least one request signal,
wherein the image data process part converts the image data into a form that can be inserted in another image data, when a watermark process request signal to insert the image data into the other image data is received from the user input part.

32. The device as claimed in claim 29, further comprising:
a user input part to transmit at least one request signal,
wherein the image data process part converts the image data into a form that can be associated with another image data, when a watermark process request signal to associate the image data with the other image data is received from the user input part.

33. The device as claimed in claim 29, wherein the image data process part converts the image data into a form to associate with another image data.

34. The device as claimed in claim 33, wherein the cable comprises one of a Universal Asynchronous Receiver and Transmitter (UART) type cable and a Universal Serial Bus (USB) type cable.

35. The device as claimed in claim 29, wherein the wireless terminal device transmits a request to the image forming device to transmit the compressed image data.

36. The device as claimed in claim 29, wherein the image forming device transmits the compressed image data without receiving a transmission request signal.

37. The device as claimed in claim 36, wherein the image forming device performs a facsimile function in transmitting the compressed image data.

38. A method of processing image data by an image forming device, comprising:
reading out scan data, by the image forming device, to generate image data;
compressing, by the image forming device, the generated image data into a transmittable form to transmit over a cable to a wireless terminal device without a separate dedicated communication module for the transmission; and
transmitting, by the image forming device, the compressed image data over the cable to the wireless terminal device.

39. The method as claimed in claim 38, wherein the cable comprises one of a Universal Asynchronous Receiver and Transmitter (UART) type cable and a Universal Serial Bus (USB) type cable.

40. The method as claimed in claim 39, further comprising:
converting, by the image forming device, the image data into a form to associate with another image data.

41. The method as claimed in claim 40, wherein the image forming device converts the image data into the form that can be associated with the other image data, when a watermark process request signal to associate the image data with the other image data is received by the image forming device.

42. The method as claimed in claim 40, wherein the image forming device converts the image data into a form that can be inserted in another image data, when a watermark process request signal to insert the image data into the other image data is received from the user input part.

43. The method as claimed in claim 38, further comprising:
converting, by the image forming device, the image data into a form to associate with another image data.

44. The method as claimed in claim 43, wherein the image forming device converts the image data into the form that can be associated with the other image data, when a watermark process request signal to associate the image data with the other image data is received by the image forming device.

45. The method as claimed in claim 43, wherein the image forming device converts the image data into a form that can be inserted in another image data, when a watermark process request signal to insert the image data into the other image data is received from the user input part.

46. The method as claimed in claim 38, further comprising:
converting, by the image forming device, the image data into a form that is insertable with another image data.

47. The method as claimed in claim 38, further comprising:
transmitting, by the wireless terminal device, a request to the image forming device to transmit the compressed image data.

48. The method system as claimed in claim 38, wherein the image forming device transmits the compressed image data without receiving a transmission request signal.

49. The method as claimed in claim 48, wherein the image forming device performs a facsimile function in transmitting the compressed image data.
